(19) United States
(12) Patent Application Publication
(10) Pub. No.: US 2018/0096362 A1
(43) Pub. Date: Apr. 5, 2018

(54) E-Commerce Marketplace and Platform for Facilitating Cross-Border Real Estate Transactions and Attendant Services

(71) Applicant: Amy Ashley Kwan, Los Angeles, CA (US)

(72) Inventor: Amy Ashley Kwan, Los Angeles, CA (US)

(21) Appl. No.: 15/723,335

(22) Filed: Oct. 3, 2017

Related U.S. Application Data
(60) Provisional application No. 62/403,324, filed on Oct. 3, 2016.

(51) Int. Cl. G06Q 30/02; G06Q 50/16; G06F 17/27

(52) U.S. Cl. CPC G06Q 30/02; G06N 99/005; G06F 17/277; G06Q 50/16

(57) ABSTRACT

An e-commerce real estate marketplace and platform includes one or more systems and methods for facilitating all aspects of cross-border real-estate transactions. Included are one or more unique machine learning techniques that together with multiple data processing steps perform mathematical calculations and/or automated reasoning tasks that allow buyers, sellers, and third parties to execute satisfactory transactions in a secure and confidential environment with complete certainty.

### CROSS-REFERENCE TO RELATED PATENT APPLICATION(S)

This application claims priority to Provisional Patent Application No. 62/403,324, filed on Oct. 3, 2016, which is hereby incorporated by reference.

### FIELD OF THE INVENTION

The present invention relates to providing services attendant to real estate transactions in an e-commerce, Internet-based marketplace platform. Specifically, the present invention relates to online concepts and techniques for the real estate industry that incorporates property listings, vetting of real estate professionals, all aspects of conducting real estate purchases and sales, ordering of ancillary services, and supply, upload, and delivery of services in a secure, web-based environment where all parties involved have quality assurances. The e-commerce marketplace and platform is therefore and Internet-based application that may be accessible both via website and via mobile application on any computing device.

### BACKGROUND OF THE INVENTION

Traditionally, the real estate evaluation and purchasing process is a complicated endeavor involving many different parties and a myriad of documents. Cross-border transactions often involve buyers from different countries who speak different languages and are unfamiliar with the process, and such transactions can be a daunting and confusing effort that often dissuades buyers from participation. There is a need not found in the existing art for an electronic platform that assists international real estate buyers in the myriad processes that entail a real estate transaction. There is also a need for such an e-commerce platform that simplifies the real estate transaction process and provides a speedy and secure business environment where all parties can confidently act with certainty.

### BRIEF SUMMARY OF THE INVENTION

Accordingly, it is one objective of the present invention to provide an electronic marketplace and platform for facilitating real estate transactions. It is another objective of the present invention to provide a secure and confidential environment within which buyers and sellers can evaluate properties and each other to successfully conclude real estate transactions with certainty. It is still another objective of the present invention to provide an e-commerce platform that includes artificial intelligence techniques for learning how to improve transaction processes between buyers and sellers and increase speed, security, and certainty in such transactions.

The present invention is an e-commerce real estate marketplace and platform in which its participant users (such as property agents, property sellers, property buyers, property renters, property service providers such as lawyers, escrow officers, appraisers, landlords, property managers, etc.) agree to terms in which users commit to provide a listing of available properties, specific services, market information, news, marketing tools, title profiles, title reports, appraisal reports, credit reports, mortgage pre-approvals, media or public relations services, etc. to other users when a property rental and/or purchase transaction is desired to take place.

One example of how such an e-commerce real estate marketplace and platform is beneficial comes in the handling of the myriad of terms involved in a real estate transaction. Many aspects of such transactions are contractual in nature and represent a warranty on the part of a user to pay for a specified service that will be consumed by another user. The terms specify that when an agreement to perform a service between two consenting parties in the e-commerce real estate marketplace and platform takes place, each party commits to pay for the service specified at stated price and perform the services agreed upon. The e-commerce real estate marketplace and platform operates to enforce the terms of the contract.

When a user is obligated by the terms of a contract to pay for or make an offer for a service, the present invention may undertake responsibility for charging the credit card or bank account on file provided by the user with a third party online application. When the user has met the requirements to receive a service per the terms of the contract as a result of agreeing to or consummating a service, the e-commerce real estate marketplace and platform is responsible for delivering the service. The ecommerce real estate marketplace and platform may also charge a service fee for the service and delivery of the service on behalf of its users. The e-commerce real estate marketplace and platform may also play the role of adjudicating or resolving disagreement or dispute between users/parties regarding obligations to pay or receive a service per the terms of the contract.

The e-commerce real estate marketplace and platform may also provide the ability for users to communicate with each other via text or other electronic messaging. The present invention may further provide a means for users to write, edit and publish their own user profiles, property profiles, reports, statements, etc. that may be viewed by other users of the e-commerce real estate marketplace and platform. Profiles may include pictures, proof of sources of fund, licenses, identification, and reports. The e-commerce real estate marketplace and platform also allows users to post photographs or videos and utilize virtual or augmented reality to portray information about users and properties. The e-commerce real estate marketplace and platform may also enable a ratings system, and addition of information to each profile to document the products and services offered by the user as they change. This allows others viewing a user profile to know, in advance, extensive details about what kind of product and service that will be provided in the event of a purchase transaction takes place. This information can therefore be a factor in a user's decision whether or not to contract with a particular user, what message to convey to users, or any decision whether to have a particular user represent them.

Other objects, embodiments, features and advantages of the present invention will become apparent from the following description of the embodiments, which illustrate, by way of example, the principles of the invention.

### BRIEF DESCRIPTION OF THE DRAWINGS

For a better understanding of the embodiments described herein and to show more clearly how they may be carried into effect, reference will now be made, by way of example only, to the accompanying drawings which show at least one exemplary embodiment, and in which:

FIG. 1 is a block diagram of the components of an e-commerce real estate marketplace and platform.

FIG. 2 is a flowchart diagram of a method of completing a real estate transaction.

FIG. 3 shows a block diagram of an embodiment of an appraiser task flow.

FIG. 4 shows a block diagram of an embodiment of an appraiser uploading documents task flow.

FIG. 5 shows a block diagram of an embodiment of a user task flow.

FIG. 6 shows a block diagram of an embodiment of a make an offer user task flow.

FIG. 7 shows a block diagram of an embodiment of a computer system suitable for use with the disclosed inventions.

FIG. 8 is a screenshot illustrating a negotiation page according to an embodiment of the present invention.

FIG. 9 is a screenshot of a review page according to an embodiment of the present invention.

FIG. 10 is a screenshot of a pending orders page according to an embodiment of the present invention.

FIG. 11 is a screenshot of a pending orders page according to an embodiment of the present invention.

### DETAILED DESCRIPTION OF THE INVENTION

In the following description of the present invention reference is made to the exemplary embodiments illustrating the principles of the present invention and how it is practiced. Other embodiments will be utilized to practice the present invention and structural and functional changes will be made thereto without departing from the scope of the present invention.

The present invention disclose one or more systems and methods of facilitating all aspects of real-estate transactions, either cross-border or otherwise, in an online environment embodied as an e-commerce real estate marketplace and platform. The present invention implements this e-commerce real estate marketplace and platform using a combination of technical applications, data processing functions, modeling methodologies, and other features, based at least in part on the products and services desired by its users.

The present invention applies one or more unique machine learning techniques together with data processing steps that together perform mathematical calculations and/or automated reasoning tasks for the e-commerce real estate marketplace and platform. The present invention is accessible via Web browser, mobile browser, or native mobile application interface, each of which provide a user interface.

It can be appreciated that the present invention enables an agency user to construct, via a user interface, an online profile that is viewable by other users to display information relevant to a real estate transaction. This information includes photographs of the agency user, and a regulatory governing body license issued to the agency user, which is provided and uploaded by the user. It may further include a text description of the agency user, and the agency user's professional experience, educational background, industry license(s), service area, and other qualifications, including personal characteristics, location, spoken languages, nationality, and error and omission (E&O) insurance policy number(s) and coverage information (and any other relevant types of insurance).

The present invention may also be configured to assist the agency user with maintaining industry licenses. For example, it may be configured to generate an email some months before his/her professional and personal licenses are set to expire, to serve as a reminder to upload updated licenses. If another user does not receive updated information by the expiry date, the agency user's information will not be searchable until licenses are updated and uploaded. In this manner, third parties or other users of the present invention have a level of satisfaction and certainty that they are dealing with fully licensed real estate professionals in the e-commerce marketplace and platform.

Users also have the ability to search for other users of the e-commerce real estate marketplace and platform, including the ability to search and sort by one or a more of the personal characteristics identified above, professional licensing and other qualifications, keyword(s) within a profile, and uploaded pictures, videos, or other content. Users therefore have the ability, within the e-commerce real estate marketplace and platform, to perform many actions, including viewing profiles of other users, sending messages to other users, and receiving messages from other users. Other functions including ordering online products and services from other users, making offers and accepting offers for online products and services, uploading and delivering the finished online products and services, and utilizing tax preparation software (for example, “TurboTax”) related to the real estate purchasing process. The e-commerce real estate marketplace and platform also provides users with the ability to purchase existing and newly-developed properties (properties under development) online, and to provide necessary signatures for accompanying documents electronically.

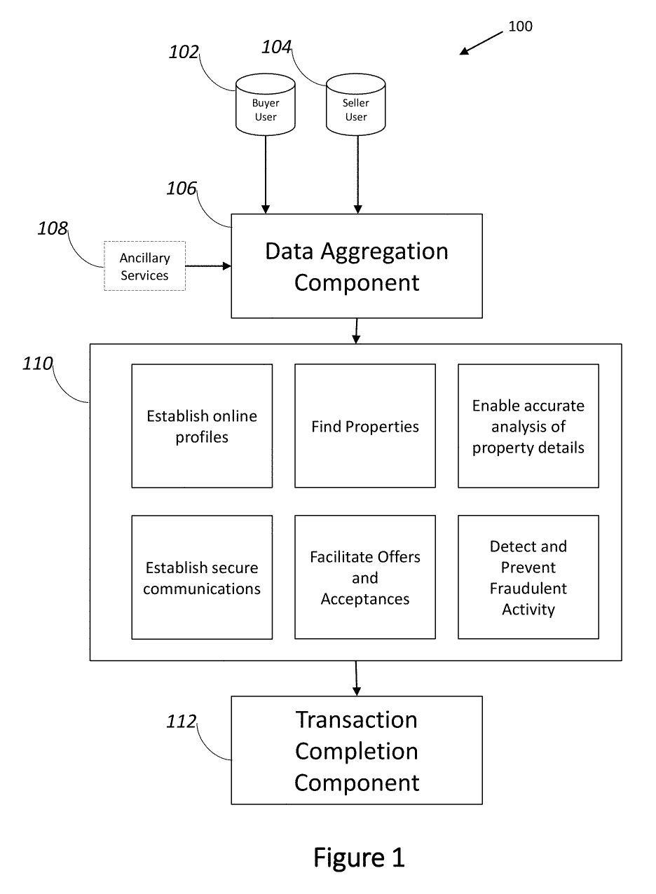

Reference is now made to FIG. 1, wherein a block diagram of the components of an e-commerce real estate marketplace and platform 100 are shown in an exemplary embodiment. A data aggregation component 106 is configured to integrate input data regarding at least one real estate buyer 102, at least one real estate seller 104, and a plurality of ancillary services 108 related to executing a real estate transaction. Ancillary services could include escrow agent information, financing and/or bank information, legal information, and other real-estate related services.

A plurality of data processing modules 110 are configured to analyze the integrated input data from the data aggregation component 106. In one embodiment, the integrated input data is analyzed in a machine learning model. Such data processing modules 110 can include modules for establishing an online profile for one or more users, finding properties, enabling accurate analysis of property details, enabling secure communications between buyers and sellers, facilitating offers and acceptances of real estate contracts, and detecting and preventing fraudulent activity.

A transaction completion component 112 is configured to input the data from the data processing modules 110 and generate one or more documents that demonstrate completion of a real estate transaction.

It is to be understood that the e-commerce real estate marketplace and platform is performed in a plurality of data processing modules within a computing environment that also includes one or more processors and a plurality of software and hardware components. The one or more processors and plurality of software and hardware components are configured to execute program instructions or routines to perform the functions described herein, and embodied within the plurality of data processing modules. The present invention may be performed wholly or partially within, and/or accessed by, a tablet-type mobile computing device, a laptop or notebook-type computing device, a phone-based device or other personal digital assistant, or any other similar devices. The computing system may include memory for storage of data and instructions configured for the execution of one or more data processing modules. The present invention may be accessed via one or more websites, or via mobile applications on the aforementioned computing and telephony devices.

In one embodiment, the e-commerce real estate marketplace and platform data processing modules 110 include data processing functions and a machine learning model that together apply a plurality of mathematical approaches to facilitating real estate transactions between users. These mathematical approaches are applied to ensure that real estate buyers and sellers, and other ancillary service providers, are able to interact with one another in a secure setting where all parties have confidence in each other and certainty in the overall process.

One such data processing function is a dimensionality reduction process, in which the number of random variables under consideration is reduced by artificial intelligence techniques. With such a process, users are able to automatically find important features they are looking for in a property. For example, users from China may tend to buy property near universities, or are looking specifically for properties with a gazebo in the backyard. The number of windows of a building might not be as important to such buyers, whereas the direction in which the front entrance is facing may be a greater decision factor. Users are also able to type in their preferred language, and the processing technique(s) applied enable searches of information in different languages, and display of search results in the preferred language. By reducing the number of random variables under consideration, search results (for example) become more accurate. This dimensionality reduction process also has advantages in that it enables reduction in the time and storage space required, removal of multi-collinearity to improve performance of a machine learning model, and easier visualization of the data when reduced to very low dimensions such as 2D or 3D. Therefore, this process enables each listing to be matched by similar listings in each category (such as similar area, similar cost, similar features, etc.) to save time in searching and in the use of processing resources.

The machine learning model may apply artificial intelligence techniques such as a k-nearest neighbor (KNN) approach that allows, for example, a map-based search to check a property's location on a map and understand its proximity to surrounding physical and social infrastructure. Such infrastructure may include highways, metro stations, bus stops, hospitals, cinema halls, schools, parks, ATMs, etc. Thus, users will be able to familiarize themselves with the amenities available to a desired property, without having to make an actual in-person visit to the location. These amenities may also be presented on a map, virtual or otherwise, displayed to users.

The present invention may cluster properties using such techniques, according to geographical characteristics (such as by school district, zip code, city, etc.), according to cost-related characteristics (such as by total price, price/sq. ft., price/number of rooms, etc.), and/or by other aspects of the property (for example, is it under auction, foreclosure, etc.), and according to recent sales or comparables. This clustering technique allows users to search for more accurate listing close to their requirements so to make more informed decisions on buying properties.

Classification using the machine learning model allows users to classify certain properties by type. One possibility is to classify a listing as a ‘good deal’ which filters out good investments from average or mediocre ones by using, for example, a most recent (e.g. 3 months) closing with similar comparables with features such as most current renovation, below market price, cash offer with quick sale, etc. in the area. Another use of classification is to highlight sellers and other professionals that are rated highly at what they do.

The present invention also applies the data processing functions to find trends in the international real estate market and company's' revenue potential from products and services. These data processing functions are used to fit models (lines) to existing data and extend it to predict future outcomes (through, for example, regression and multilevel models). Therefore another example of a data processing function is a regression analysis, which is used to find the best-fit lines to data. Another example is, as noted, a multilevel model that is a collection of regression analyses built on each other. The present invention may also use more than one model for all neighborhoods, since each neighborhood has different properties. Individual models may be used for each neighborhood, and a model linking each neighborhood. Relevant descriptive statistics may also be used to calculate, for example, a percentage of viewers that actually make an offer. Trends and outliers may be used to identify with data visualization techniques, like plotting various features against others. Data processing techniques may also be used to test the site (alpha versus beta) which gives users different versions of the same site, chosen at random. In such a case, a site which produces more deals or has a higher satisfaction rating would be chosen.

Another such data processing function includes one or more recommender systems that provide relevant high ranking preferences personalized for each user and each listing. This helps buyers find houses that match their preferences automatically. Such systems may also be able to recommend sellers to users that tend to sell in a particular geographical area. The present invention may apply such systems to recommend a list of sellers to listing agents that have been buying and selling in the same geographical area and the price range information, and vice versa. Therefore, agents who work in this area have more experience and local product knowledge, and these would be matched with other uses where a high preference for such expertise in listings is expressed.

Another aspect of the present invention involves predictive marketing with “smart” data. The present invention may apply a predictive analysis as a data processing function to predict future behavior using existing data about past behavior. The present invention can therefore predict which properties in a neighborhood (currently not listed for sale) would have the highest likelihood to sell in the next 12 months.

For example, in such a predictive analysis, every week the e-commerce real estate marketplace and platform obtains the latest property sales data and matches it with properties that are predicted to sell. A scoring methodology may be applied that identifies which properties are likely to sell in a certain time period, such as the next x number of months. This can be utilized by listing agents to solicit upcoming listings. Predictive marketing also enables a real estate agent's brand to be considered by the property owner before a decision is made on who will list the property.

Another data processing function within the scope of the present invention is Natural Language Processing (NLP), which allows extraction of important information from language (usually text). For example, if a listing mentions the word “quiet” and “safe” then the present invention extracts these important features from the text automatically. It is also possible to tokenize (split paragraphs into words) in Chinese and English separately, and then link these words (known as feature engineering). When a potential property buyer searches in Chinese for certain requirements, after language processing and clustering, the English results will quickly be returned in Chinese. Similarly, if a Chinese agent sends a Chinese-language inquiry to an English speaking agent, the inquiries will appear as English so the English-speaking agent would understand the inquiry.

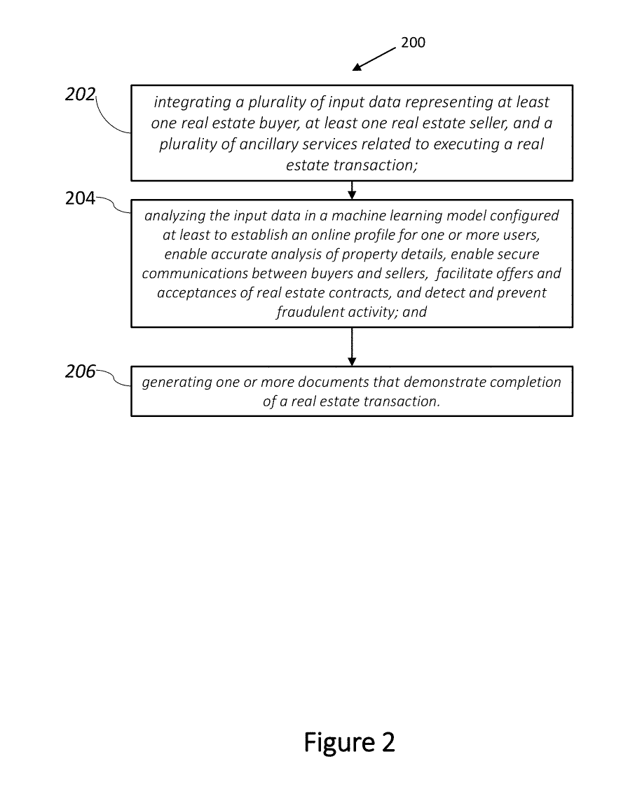

FIG. 2 is a flowchart diagram of a method of completing a real estate transaction 200 according to an embodiment of the invention. Step 202 comprises integrating a plurality of input data representing at least one real estate buyer, at least one real estate seller, and a plurality of ancillary services related to executing a real estate transaction. Step 204 comprises analyzing the input data in a machine learning model configured at least to establish an online profile for one or more users, enable accurate analysis of property details, enable secure communications between buyers and sellers, facilitate offers and acceptances of real estate contracts, and detect and prevent fraudulent activity. Step 206 comprises generating one or more documents that demonstrate completion of a real estate transaction.

As noted above, multiple applications may be integrated into the e-commerce marketplace and platform, so that it in effect functions as the “TurboTax” of real estate transactions. The data processing functions discussed herein may therefore be applied to provide for simplicity and non-cluttered workflows in the real estate transactions process. For example, important keywords in different languages used by buyers and sellers are automatically translatable (such as between Chinese or English) for simplicity, and workflows are simplified so that not too much information per page is displayed. These functions allow for stepping the user through the various aspects involved in the real estate buying/selling process. This is relevant where there are lots of random items that are required in a deal (such as fire insurance, termites, property insurance, electricity/internet, sewage, etc.). The buying agent/buyer can order the required product and service, such as an appraisal, and can select which professional they want to work with so that there is no conflict of interest involved.

Embedded recommender systems also enable a rating system, where ratings are generated by algorithms based on years of experience of agent, type of governmental regulatory license held, and existing ratings and reviews by completed transaction parties, service providers, etc. For example, a non-U.S. property buyer does not know all of the details and processes involved, and would like recommendations to simplify the process at each step. Further to such an example, fire insurance can be chosen from a list generated by algorithms (such as a “nearest neighbor” for indifferent aspects including distance, ratings, turnaround time, pricing, licensed). Appraiser lists may be generated by one or more algorithms (relative to, for example, zip code, pricing, turnaround time, type of appraisal, etc.).

Virtual reality (VR) components and processes may also be included in the ecommerce real estate marketplace and platform. Such virtual reality technology is emerging as a powerful tool in selling property developments off-the-plan, i.e. before they have even been built. VR allows prospective buyers to experience the space even before construction has started. Traditionally, developers put up a sample flat at the project site which potential buyers visited, or provided a building model in an office. The portal of the present invention offers online virtual reality tours, using visualization software. Cameras may be fitted on unmanned flight vehicles (commonly referred to as drones) to obtain the relevant imagery to create a realistic virtual experience by incorporating high-quality, computer-generated images and combining these with photography, allowing buyers to sit in the apartment and see the actual view. Interested buyers can see the property from different angles, how the property would look at different times of the day, sample the view from the balcony, and compare the unit plans of various front door-facing directions. An aerial view may also show the property and its neighborhood. Buyers using such a virtual reality “tour” would have the benefit of knowing that what they see is what they will get. Data points may also be obtained about each property from on-site visits or acquired directly from developers. Hence, any information available on the portal about the project is authentic and verified.

Another aspect of the present invention involves acting as an operator for facilitating offers, and acceptances of offers, for example for new developments. The present invention may therefore be considered as a toolset for dedicated developers of projects and for buyers of such properties, through which online offering and acceptance for people living in other cities or countries can be effectuated. Such people may register on a dedicated website for such projects, and choose the project size and a payment plan, and book the property by paying the booking amount online (and such booking amount may be returned within a stipulated period of time if the purchaser elects not to proceed with the purchase). Allotment of an exact or specific property, for example an apartment, may also occur online using such a dedicated site. It should be noted that such tools are to be supplemented with physical, offline research. The present invention also provides verification of a developer's or builder's history or track record regarding timely completion of projects, as well as building quality, by linking with information on past/older projects. The present invention may also provide, or link with, the services of experts to verify the authenticity of various documents provided by the developer with the city (or other regulatory) planning office.

The present invention therefore offers a high level of transparency, and incorporates many confidence-building measures so that the entire real estate purchasing process is facilitated online. Once an offer is accepted to and agreed upon by both parties, an electronic message will automatically be generated and sent to respective service providers to invite them to commence their respective process.

The machine learning model of the present invention may apply additional artificial intelligence techniques, such as a method of learning ensembles of decision trees known as random forests. A random forest algorithmic model may be applied to estimate market value based on weekly and/or monthly data supplied from the MLS listing site. The machine learning model of the present invention provides an estimate of how likely a buyer will successfully pay for a house. To improve the outcome of such a model to estimate market value, the present invention may further include one or more time series models based on existing economic data.

A random forest approach may also be applied to calculate the estimated current market value of a home by using the most recent sales of comparable houses with transfer price in a particular area within, for example, three months, and six months from MLS, as well as future market value within, for example, the next three and six months. So a purchaser will be able to estimate what price to offer for a property to buy, and a seller can price their property to sell. The present invention therefore allows users to check the accuracy of market value in their own region against actual sales.

A data clustering method may further be applied to automatically value a sales transaction to arrive at appropriate comparables to offer highly accurate “smart” data for a market value of a property. Such a method would seek the most relevant data for such a valuation, and for example may exclude the last mortgage bank's assessment for a home's value because some of this data is very “stale.” Even home descriptions may be inaccurate for such a valuation.

An embedded recommender system approach may further be applied to order an appraisal. The present invention may therefore include an appraisal order feature before a buying agent/buyer offer is made to purchase a property. Under such an approach, a buyer is offered a step to order either a drive-by, desktop, or full appraisal to appraise a property before offering a price. The embedded recommender system is therefore applied before he/she presents an online offer of purchase, so as to make sure he/she is comfortable with the offering price. This allows the buyer the choice to pick an appraisal based on the area by zip code, cost, and turnaround time. Using a link to a third party site, the buyer pays for the appropriate appraisal fee through a third party/operator, and the appraiser receives the order. The present invention may invite the buyer to upload his banking/credit payment info to pay for and accept the service fee. As soon as this payment process is done, an email receipt will be sent to invite the appraiser to start working on the appraisal. When finished with the appraisal, the appraiser can then upload the report to the buyer's page, and an electronic message will inform buyer the appraisal is complete, with an invitation to view the appraisal and make an offer to purchase the property.

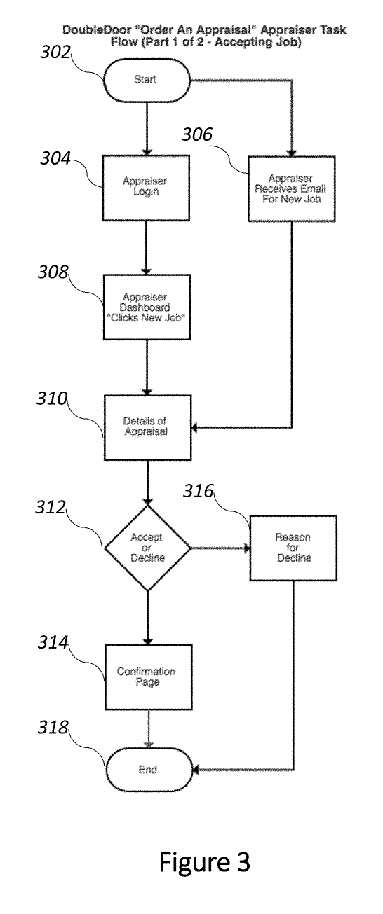

FIG. 3 shows a block diagram of an embodiment of an appraiser task flow. The process starts at step 302, where an appraiser can either login at step 304 and then click new job at the appraiser dashboard at step 308, or the appraiser receives an email for a new job at step 306. Both of these lead to details of the appraisal at step 310. Next, the appraiser can either accept or decline the job at step 312. If the appraiser accepts the job at step 312, then the method proceeds to step 314 where a confirmation page is displayed, and then the method ends at step 318. If the appraiser rejects the job at 312, the method proceeds to step 316 to inquire from the appraiser as to the reason for declining the job, and then the method ends at step 318.

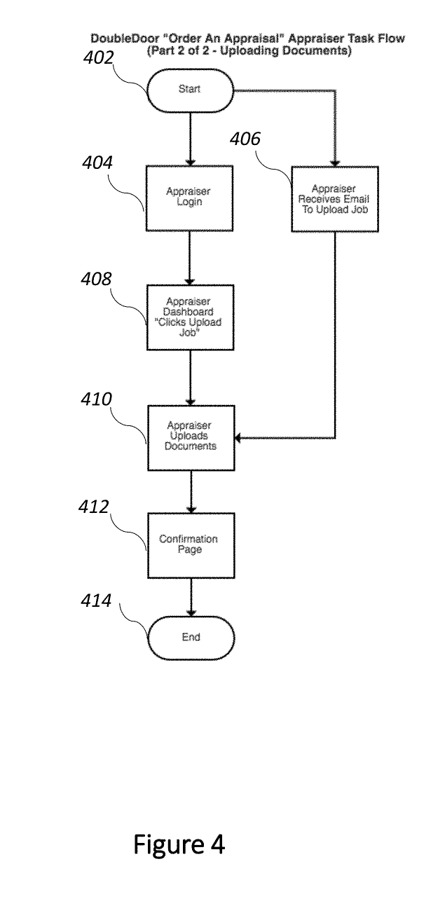

FIG. 4 shows a block diagram of an embodiment of an appraiser uploading documents task flow. The process starts at step 402, where an appraiser can either login at step 404 and then click upload job from the appraiser dashboard at step 408, or an appraiser receives an email to upload a job at step 406. The process then goes to step 410 where the appraiser uploads documents. After uploading the pertinent documents the process goes to a confirmation page at step 412, and the process finally ends at step 414.

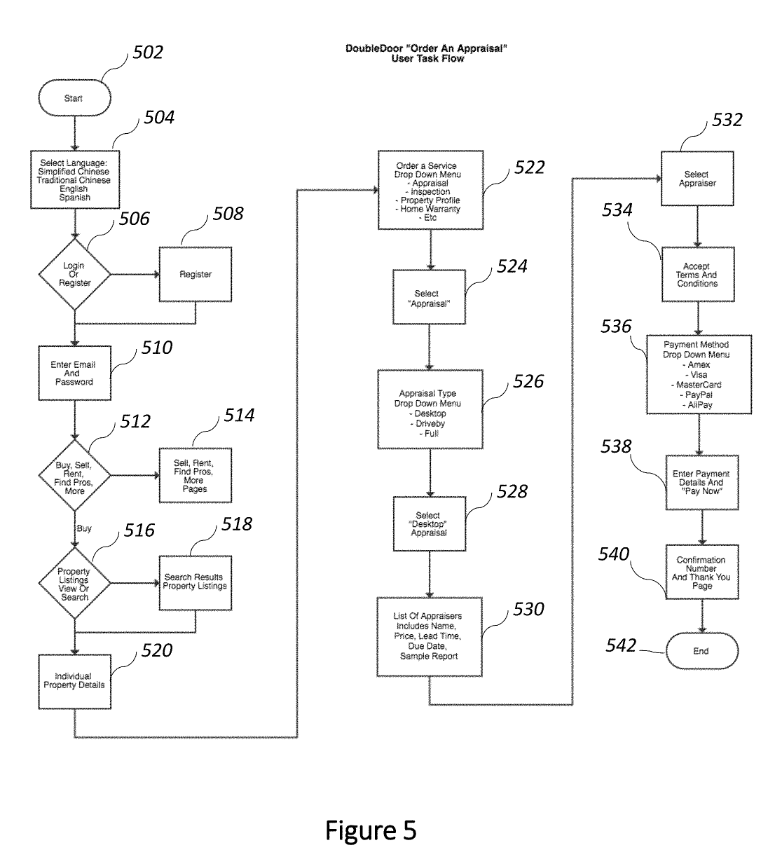

FIG. 5 shows a block diagram of an embodiment of a user task flow. The process starts at step 502, where a user can select their language at step 504. The user is then prompted to login or register at step 506. If the user does not have an account, they create one at step 508 and then enter their login information at step 510. At step 512, a user has the option to buy which takes the user to step 516, or to sell, rent, or find pros at step 514.

If the user chooses to buy, at step 516 they can either view or search property listings at step 518. At step 520, a user enters the individual property details. At step 522, a user orders a service such as appraisal, inspection, property profile, or home warranty. At step 524, a user selects appraisal, and then at step 526 the user selects the appraisal type (either desktop, drive by, or full). If the user selects desktop appraisal at step 528, then the method goes to step 530 where the list of appraisers includes name, price, lead time, due date, and sample report. A user then selects an appraiser at step 532. At step 534, the user accepts the terms and conditions. At step 536, the user enters in their payment information. At step 538, the user enters payment details, and at step 540 the confirmation number and thank you page is displayed. The process stops at step 542.

The present invention also includes an “offer” feature that facilitates initiation of online real estate purchases. A specific offer page may be provided for such a feature, which includes similar information to the actual purchase offer joint escrow instruction form in a traditional purchasing process. The offer page includes the ability to enter the property address and information such as whether they are a married couple/joint tenant, tenant in common, corporation, etc., title instructions, and source of funding. After selecting an “offer” link, the present invention prompts the buyer to make payment, by initiating a transaction facilitating payment of a security deposit to the third party/operator that is held until the offer is accepted by seller/selling agent. After the offer is accepted, a page will be displayed with links of all the forms buyer needs to sign or have.

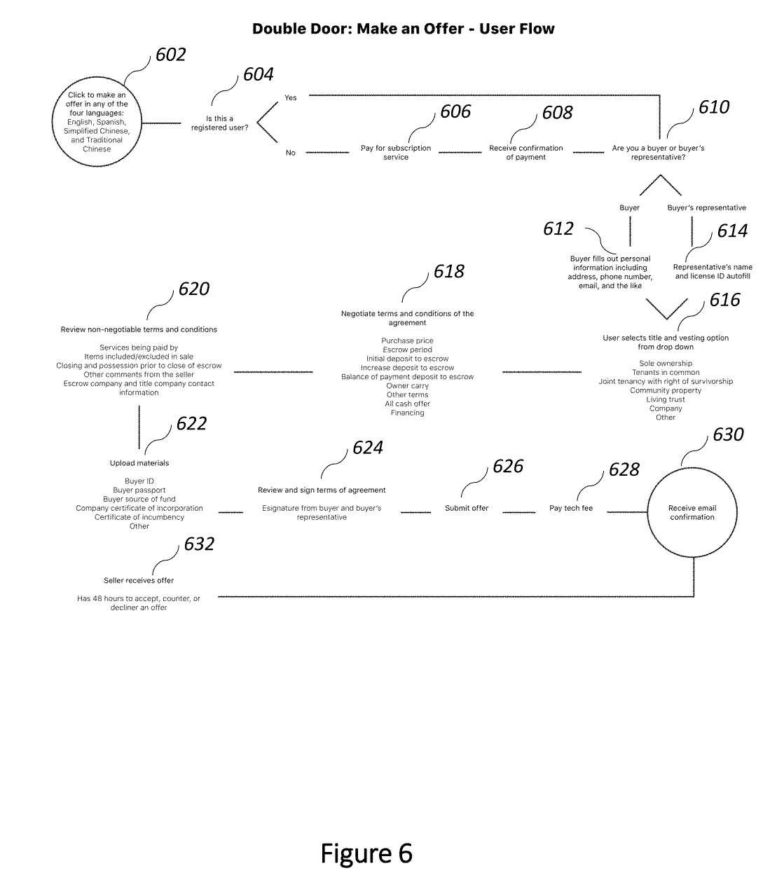

FIG. 6 shows a block diagram of an embodiment of a make an offer user task flow. At step 602, a user can click to make an offer in a plurality of languages. In one embodiment, there are four languages: English, Spanish, Simplified Chinese, and Traditional chinese.

At step 604, the system checks whether this is a registered user. If yes, it jumps to step 610. Otherwise, at step 606 a user pays for a subscription service. At step 608, a user receives confirmation of payment. At step 610, the user is prompted whether they are the buyer or the buyer's representative.

If the user is the buyer, the method goes to step 612 where the buyer fills out personal information including address, phone number, and email. If the user is the buyer's representative, the method asks for the representative's name and license ID. In one embodiment, the name is auto filled from the license ID.

In step 616, the user selects title and vesting options. Such as sole ownership, tenants in common, joint tenancy with right of survivorship, community property, living trust, company, or other title and vesting options.

At step 618, the user negotiates terms and conditions of the agreement including: purchase price, escrow period, initial deposit to escrow, increase deposit to escrow, balance of payment deposit to escrow, owner carry, other terms, all cash offer, and financing. At step 620, the user reviews non-negotiable terms and conditions. These include services being paid by items included/excluded in sale, closing and possession prior to close of escrow, other comments from the seller, and escrow company and title company contact information.

At step 622, the user uploads materials including buyer ID, buyer passport, buyer source of funds, company certificate of incorporation, certificate of incumbency and related documents.

At step 624, the user reviews and signs the terms of agreement. In one embodiment, this includes an e-signature from the buyer and/or the buyer's representative.

At step 626, the buyer submits an offer and at step 628 the user pays the tech fee. At step 630, the user receives an email confirmation and at step 632, the seller receives the offer. In one embodiment, the seller has 48 hours to accept, counter, or decline the offer,

The e-commerce real estate marketplace and platform of the present invention also includes, as part of its machine learning model, a supervised learning engine that at least in part allows a user to register to prevent account sharing. In this supervised learning engine, output datasets are provided when a user signs up for such a service. As part of the sign up process, a user's facial features may be recorded for future recognition purposes. The facial features may be used to train the machine learning model and to “learn” desired results and strengthen account security. One purpose of such a supervised learning engine applied to account sharing prevention services is to prevent multiple users using the same account, and system abuse.

The data processing functions of the present invention may also include knowledge discovery in databases (KDD), data mining, and machine learning and statistics for fraud detection. Real estate is an area of high fraud potential, and techniques used for fraud detection generally fall into two primary classes: statistical techniques and artificial intelligence. The present invention applies the statistical data analysis techniques below to prevent banking fraud, wire fraud, credit card fraud, source of fund fraud, fraudulent development projects, etc. by users.

Many data preprocessing techniques may be incorporated for detection, validation, error correction, and entering missing or incorrect data in the e-commerce real estate marketplace and platform. The present invention includes calculation of various statistical parameters such as averages, quintiles, performance metrics, probability distributions, and so on. For example, the averages calculated may include average length of call, average number of calls per month and average delays in bill payment.

Models and probability distributions of various business activities either in terms of various parameters or probability distributions may also be performed. Additional mathematical processing may be applied to compute data for user profiles, a time-series analysis of time-dependent data, and clustering and classification to find patterns and associations among groups of data.

Matching algorithms may be employed to detect anomalies in the behavior of transactions or users as compared to previously known models and profiles. Techniques are also applied to eliminate false alarms, estimate risks, and predict future or current transactions or users.

The e-commerce real estate marketplace and platform may further calculate Bayesian probabilities as measures of confidence with a set of probabilities that the market believes that real estate is about to get more expensive based on what buyers are willing to pay. On the other hand, sometimes market behavior is not rational, and the use of Bayesian probabilities are useful for identifying a market bubble in irrational circumstances.

Examples of a time series analysis in the data processing functions of the present invention include ARIMA or GARCH models, and neural networks, which are used to identify, for example, U.S. cities with investment return based on demographics, property price, rental market availability, and sale history to suggest that city for foreign investors to invest in. Artificial neural networks may be used for particular solutions concerning real estate valuation, such as selection of real estate features which highly influence the determination of property value.

Various types of artificial neural networks may be included in the machine learning model for comparison of data to increase accuracy in the determination of property values in the present invention. Examples include multi-layer perception (MLP), networks of radial base functions (RBF), and linear networks. Obtained values of accuracy of real estate valuation are compared with the values of accuracy, which may be obtained using a multiple regression method. The end result or product may be further applied to help the agent to solicit property listing.

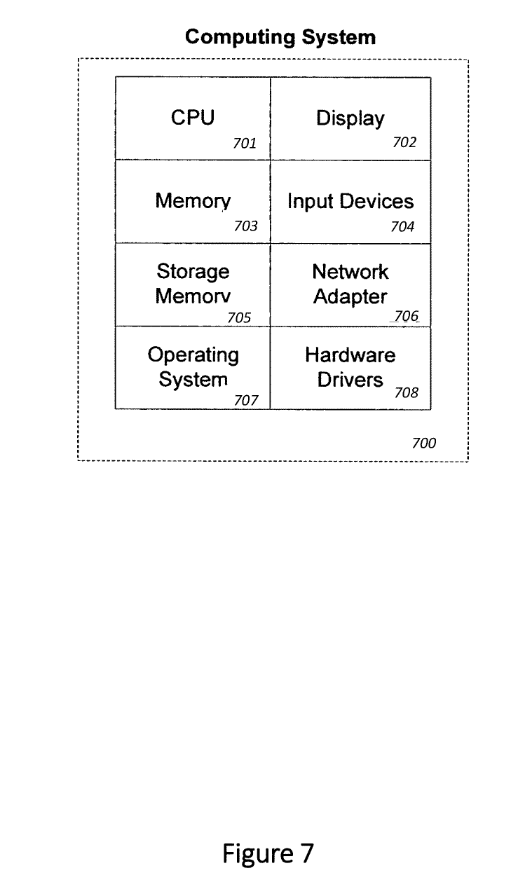

FIG. 7 shows a block diagram of an embodiment of a computer system suitable for use with the disclosed inventions. The Computer system 700 may comprise: a Central Processing Unit “CPU” 701 for executing commands; an optional Display 702 for conveying visual information to a user; Memory 703 for temporarily holding information and instructions; optional Input Devices 704 which can include a keyboard, mouse, microphone or other apparatus for entering instructions or data; Storage Memory 705 which stores information and software applications; a Network Adapter 706 for communicating over the Internet, local area network, or other network; an Operating System 707 for coordinating between the various components and software applications; and various Hardware Drivers 708 that allow the operating system to communicate with physical elements of the Real Estate system.

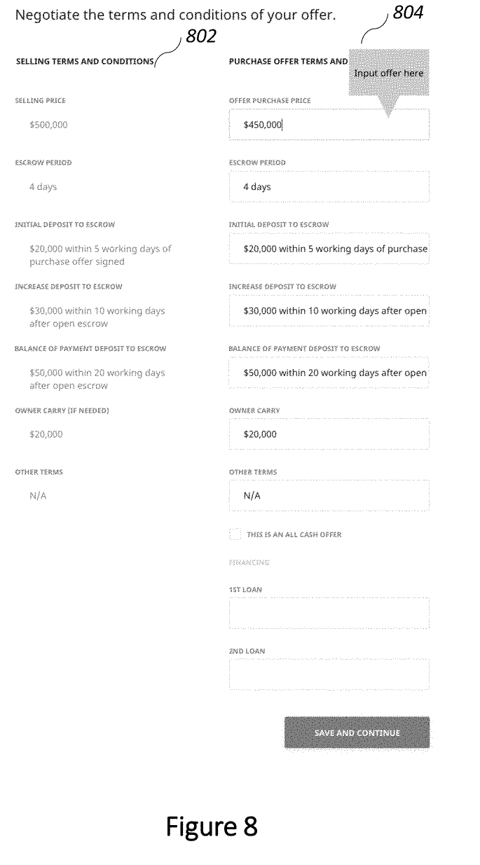

FIG. 8 is a screenshot illustrating a negotiation page from a buyer's perspective according to an embodiment of the present invention. As shown in FIG. 8, the e-commerce marketplace and platform may also generate and provide a negotiation platform which displays selling terms and conditions 802 and purchase terms and conditions 804. In this page, the important terms and conditions such as price, escrow details, etc are negotiated between the buyer and seller. Financing information is also entered by purchaser.

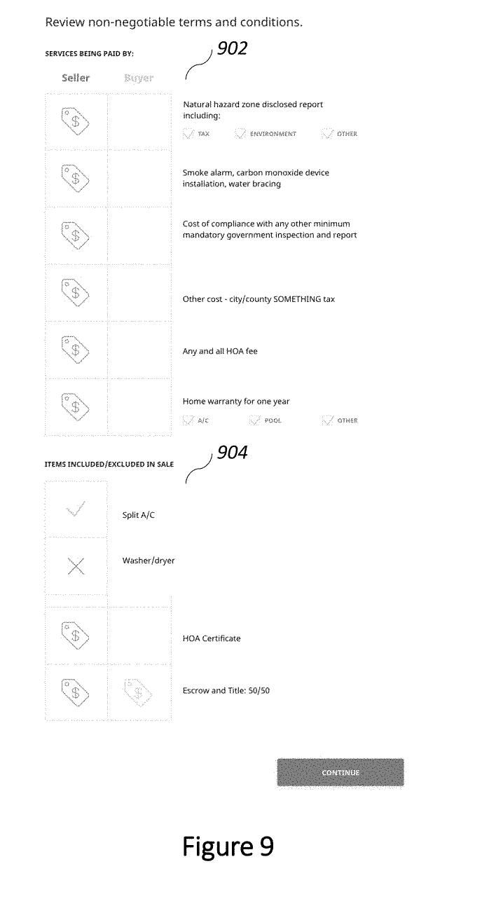

FIG. 9 is a screenshot of a review page according to an embodiment of the present invention. As shown in FIG. 9, the e-commerce marketplace and platform may also generate and provide information pertaining to a review of non-negotiable terms and conditions including the services being paid by options section 902 which specifies whether the buyer or seller is paying for a list of services such as fees, alarms, natural hazard zone disclosed reports, warranty information, and other ancillary services. This page also includes items included/excluded section 904 such as air conditioning, HOA certificate, escrow, and other ancillary items and services.

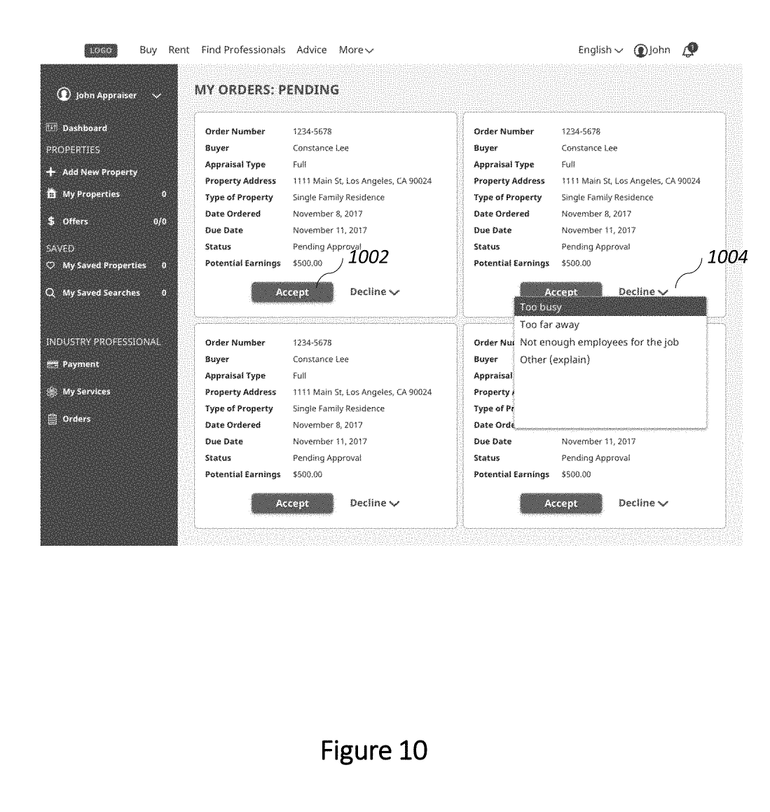

FIG. 10 is a screenshot of a pending orders page according to an embodiment of the present invention. As shown in FIG. 10, the e-commerce marketplace and platform may also generate and provide information pertaining to an appraiser accepting orders via an accept button 1002 or declining, via decline dropdown 1004 and specifying the reason for declining such as too busy or too far away.

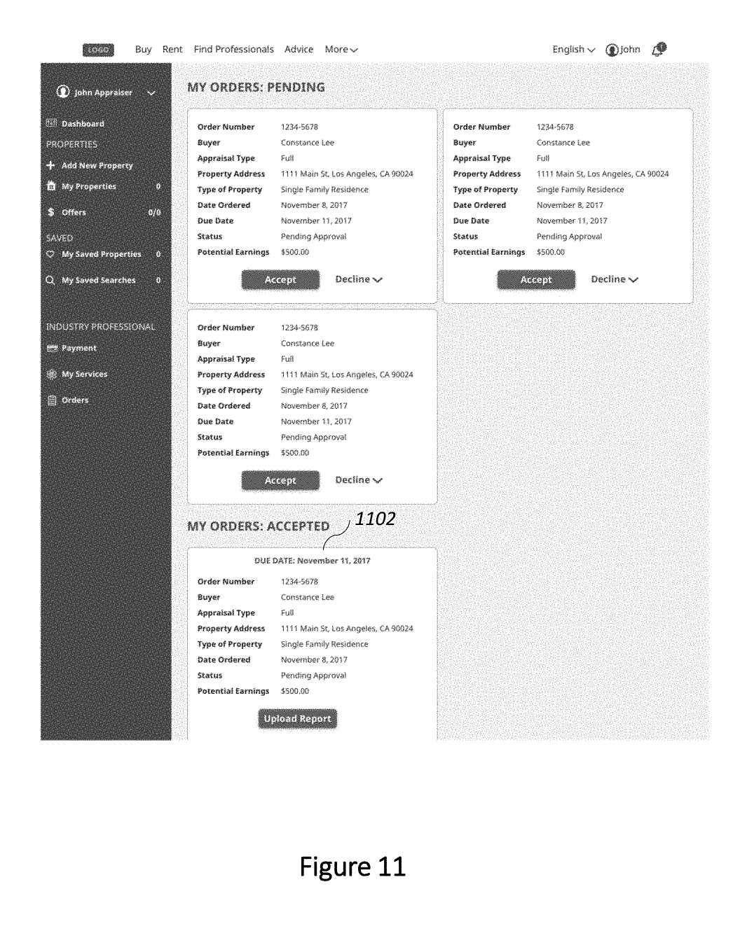

FIG. 11 is a screenshot of a pending orders page according to an embodiment of the present invention. As shown in FIG. 11, the e-commerce marketplace and platform may also generate and provide information pertaining to an appraiser accepting orders including an accepted orders section 1102 where the appraiser can see the orders previously accepted and upload a report.

The systems and methods of the present invention may be implemented in many different types of computing environments. For example, they may be implemented in conjunction with a special purpose computer, a programmed microprocessor or microcontroller and peripheral integrated circuit element(s), an ASIC or other integrated circuit, a digital signal processor, electronic or logic circuitry such as discrete element circuit, a programmable logic device or gate array such as a PLD, PLA, FPGA, PAL, and any comparable means. In general, any means of implementing the methodology illustrated herein can be used to implement the various aspects of the present invention. Exemplary hardware that can be used for the present invention includes computers, handheld devices, telephones (e.g., cellular, Internet enabled, digital, analog, hybrids, and others), and other such hardware. Some of these devices include processors (e.g., a single or multiple microprocessors), memory, nonvolatile storage, input devices, and output devices. Furthermore, alternative software implementations including, but not limited to, distributed processing, parallel processing, or virtual machine processing can also be configured to perform the methods described herein.

The systems and methods of the present invention may also be partially implemented in software that can be stored on a storage medium, non-transitory or otherwise, executed on programmed general-purpose computer with the cooperation of a controller and memory, a special purpose computer, a microprocessor, or the like. In these instances, the systems and methods of this invention can be implemented as a program embedded on personal computer such as an applet, JAVA® or CGI script, as a resource residing on a server or computer workstation, as a routine embedded in a dedicated measurement system, system component, or the like. The system can also be implemented by physically incorporating the system and/or method into a software and/or hardware system.

Additionally, the data processing functions disclosed herein may be performed by one or more program instructions stored in or executed by such memory, and further may be performed by one or more modules configured to carry out those program instructions. Modules are intended to refer to any known or later developed hardware, software, firmware, artificial intelligence, fuzzy logic, expert system or combination of hardware and software that is capable of performing the data processing functionality described herein.

The foregoing descriptions of embodiments of the present invention have been presented for the purposes of illustration and description. It is not intended to be exhaustive or to limit the invention to the precise forms disclosed. Accordingly, many alterations, modifications and variations are possible in light of the above teachings, may be made by those having ordinary skill in the art without departing from the spirit and scope of the invention. It is therefore intended that the scope of the invention be limited not by this detailed description. For example, notwithstanding the fact that the elements of a claim are set forth below in a certain combination, it must be expressly understood that the invention includes other combinations of fewer, more or different elements, which are disclosed in above even when not initially claimed in such combinations. It is to be understood that many different mathematical equations, calculations, functions, manipulations, and models may be used to accomplish the underlying premises disclosed herein.

The words used in this specification to describe the invention and its various embodiments are to be understood not only in the sense of their commonly defined meanings, but to include by special definition in this specification structure, material or acts beyond the scope of the commonly defined meanings. Thus if an element can be understood in the context of this specification as including more than one meaning, then its use in a claim must be understood as being generic to all possible meanings supported by the specification and by the word itself.

The definitions of the words or elements of the following claims are, therefore, defined in this specification to include not only the combination of elements which are literally set forth, but all equivalent structure, material or acts for performing substantially the same function in substantially the same way to obtain substantially the same result. In this sense it is therefore contemplated that an equivalent substitution of two or more elements may be made for any one of the elements in the claims below or that a single element may be substituted for two or more elements in a claim. Although elements may be described above as acting in certain combinations and even initially claimed as such, it is to be expressly understood that one or more elements from a claimed combination can in some cases be excised from the combination and that the claimed combination may be directed to a sub-combination or variation of a sub-combination.

Insubstantial changes from the claimed subject matter as viewed by a person with ordinary skill in the art, now known or later devised, are expressly contemplated as being equivalently within the scope of the claims. Therefore, obvious substitutions now or later known to one with ordinary skill in the art are defined to be within the scope of the defined elements.

The claims are thus to be understood to include what is specifically illustrated and described above, what is conceptually equivalent, what can be obviously substituted and also what essentially incorporates the essential idea of the invention.

1. A system, comprising:
a computing environment including one or more computer processors and at least one computer-readable storage medium operably coupled to the one or more computer processors and having program instructions stored therein, the one or more computer processors being operable to execute the program instructions to perform an ecommerce real estate marketplace and platform;
a data aggregation component configured to integrate input data regarding at least one real estate buyer, at least one real estate seller, and a plurality of ancillary services related to executing a real estate transaction;
a plurality of data processing modules configured to analyze the input data in a machine learning model for: establishing an online profile for one or more users, enabling accurate analysis of property details, enabling secure communications between buyers and sellers, facilitating offers and acceptances of real estate contracts, and detecting and preventing fraudulent activity; and
a transaction completion component configured to generate one or more documents that demonstrate completion of a real estate transaction.

2. The system of claim 1, wherein the analyzing of input data further comprises tokenizing words in Chinese and English separately, and then linking these words together.

3. The system of claim 2, wherein the tokenizing is performed via language processing and clustering.

4. The system of claim 3, where the analyzing of input data further comprises classifying properties by type.

5. The system of claim 4, wherein the classification of properties by type further comprises filtering desirable investments by analyzing features including a below market price or a cash offer with quick sale.

6. The system of claim 4, wherein the classification of properties by type further comprises filtering desirable investments by analyzing highly rated sellers.

7. The system of claim 6, wherein the analyzing of input data further comprises grouping properties according to geographical characteristics, cost-related characteristics, and recent sales or comparables.

8. The system of claim 7, wherein the geographical characteristics further comprise school district, zip code, and city information.

9. The system of claim 8, wherein the cost-related characteristics further comprise total price, price per square foot, and price per number of rooms.

10. The system of claim 9, where in the analyzing of input data further comprises a predictive analysis as a data processing function to predict future behavior using existing data about past behavior.

11. A method, comprising:
integrating input data representing at least one real estate buyer, at least one real estate seller, and a plurality of ancillary services related to executing a real estate transaction;
analyzing the input data by a plurality of data processing modules in a machine learning model configured at least to: establish an online profile for one or more users, enable accurate analysis of property details, enable secure communications between buyers and sellers, facilitate offers and acceptances of real estate contracts, and detect and prevent fraudulent activity; and
generating one or more documents that demonstrate completion of a real estate transaction.

12. The method of claim 11, wherein the analyzing of input data further comprises tokenizing words in Chinese and English separately, and then linking these words together.

13. The method of claim 12, wherein the tokenizing is performed via language processing and clustering.

14. The method of claim 13, where the analyzing of input data further comprises classifying properties by type.

15. The method of claim 14, wherein the classification of properties by type further comprises filtering desirable investments by analyzing features including a below market price or a cash offer with quick sale.

16. The method of claim 14, wherein the classification of properties by type further comprises filtering desirable investments by analyzing highly rated sellers.

17. The method of claim 16, wherein the analyzing of input data further comprises grouping properties according to geographical characteristics, cost-related characteristics, and recent sales or comparables.

18. The method of claim 17, wherein the geographical characteristics further comprise school district, zip code, and city information.

19. The method of claim 18, wherein the cost-related characteristics further comprise total price, price per square foot, and price per number of rooms.

20. The method of claim 19, where in the analyzing of input data further comprises a predictive analysis as a data processing function to predict future behavior using existing data about past behavior.
